(19) United States
(12) Patent Application Publication
(10) Pub. No.: US 2023/0280172 A1
(43) Pub. Date: Sep. 7, 2023

(54) System and Method for Providing Route Guidance Services

(71) Applicants: Hyundai Motor Company, Seoul (KR); Kia Corporation, Seoul (KR)

(72) Inventors: Nam Chung Paik, Goyang-si (KR); Kimyoung Hong, Seoul (KR)

(21) Appl. No.: 17/879,528

(22) Filed: Aug. 2, 2022

(30) Foreign Application Priority Data
Mar. 7, 2022 (KR) 10-2022-0028706

(51) Int. Cl. G01C 21/34; G01C 21/36

(52) U.S. Cl. CPC G01C 21/3461; G01C 21/3484; G01C 21/3617; G01C 21/3691

(57) ABSTRACT

An embodiment system for providing route guidance services includes a service providing server receiving configured to receive a route guidance request from a user terminal, derive a plurality of retrieved routes based on a departure point and a destination point, predict a plurality of required times corresponding to the plurality of retrieved routes, respectively, determine a target route of which a stress index is to be calculated among the plurality of retrieved routes considering the plurality of required times, calculate a first stress index of the determined target route using information on a plurality of stress factors and a plurality of weight values corresponding to the plurality of stress factors, respectively, for the determined target route, and transmitting transmit information about target routes to the user terminal in response to the route guidance request.

### CROSS-REFERENCE TO RELATED APPLICATIONS

This application claims priority to and the benefit of Korean Patent Application No. 10-2022-0028706, filed in the Korean Intellectual Property Office on Mar. 07, 2022, the entire contents of which are incorporated herein by reference.

### TECHNICAL FIELD

The present disclosure relates to a system and a method for providing route guidance services.

### BACKGROUND

Driving obstacles and traffic environments that drivers experience while driving vehicles cause a lot of stress regardless of how long they have been driving, and the drivers’ stress may lead to accidents.

There have already been some studies on driving stress scale, but the studies are merely psychological studies for identifying drivers with high stress in high-risk groups, and there has been no attempt to convert stress factors into indexes to provide the indexes of the stress factors as information for the drivers.

Thus, there is a need to develop a route guidance system capable of reducing drivers’ driving stress by comprehensively considering various stressful situations to be induced during driving.

The above information disclosed in this background section is only for enhancement of understanding of the background of the invention, and therefore it may contain information that does not form the prior art that is already known to a person of ordinary skill in the art.

### SUMMARY

Embodiments of the present invention can provide route guidance systems and methods having advantages of reducing drivers’ driving stress by considering not only route guidance condition items in conventional navigation devices, such as ‘shortest distance’, ‘shortest time’, and ‘toll/free road’ but also factors affecting the drivers’ driving stress.

An exemplary embodiment of the present invention provides a system for providing route guidance services, the system including a service providing server receiving a route guidance request from a user terminal, and transmitting information about target routes to the user terminal in response to the request, wherein the service providing server derives a plurality of retrieved routes based on a departure point and a destination point, predicts a plurality of required times corresponding to the plurality of retrieved routes, respectively, determines at least one of the target routes of which a stress index is to be calculated among the plurality of retrieved routes considering the plurality of required times, and calculates a first stress index of the determined target route using information on a plurality of stress factors and a plurality of weight values corresponding to the plurality of stress factors, respectively, for the determined target route.

The service providing server may include a navigation module retrieving routes from the departure point to the destination point, and a stress index calculating module checking a driver type, determining basic weight values of the respective stress factors for each of the target routes, calculating stress values of the respective stress factors using the basic weight values of the respective stress factors, calculating indexes of the respective stress factors by applying a special weight value to the calculated stress values of the respective stress factors, calculating a first stress index for each of the target routes by adding up the calculated indexes of the respective stress factors, and the basic weight values may be values given to the respective stress factors.

The system may further include an index reflection ratio applying module calculating a second stress index by applying an index reflection ratio to the calculated first stress index for each of the target routes.

The stress index calculating module may calculate the stress value of each of the stress factors by multiplying the basic weight value for each of the stress factors by the number of times each of the stress factors is present.

Each driver type may be distinguishing in that the basic weight value of at least one stress factor among the plurality of stress factors is high.

The stress index calculating module may calculate the index of each of the stress factors by multiplying the calculated stress value for each of the stress factors by the special weight value, the special weight value may be a value for reflecting a state of the stress factor, and the state of the stress factor may include at least one of whether the stress factor is consecutively present and a length of the stress factor.

The basic weight value for each of the stress factors may be determined based on weather information, whether each of the stress factors is present or absent, the number of times each of the stress factors is present, and whether each of the stress factors is consecutively present for each of the target routes.

The weather information may include information about weather, such as sunny, snowing, or raining, in a region on the target route, and the basic weight value for each of the stress factors may be higher when the weather in the region on the target route is snowing or raining than when the weather in the region on the target route is sunny.

The stress factors may include one or more of a speed bump, a sharp curve section, a frequent accident spot, a tunnel section, a road depression section (pothole), a one-way road, an overspeed monitoring camera, a child protection zone (school zone), a senior protection zone, a traffic light without a crosswalk and an unprotected left turn signal, a traffic light with a crosswalk, a traffic light with an unprotected left turn signal, and a traffic light with a crosswalk and an unprotected left turn signal.

The target routes may be one or more routes each of which a required time is 120% or less of a shortest required time among the plurality of retrieved routes.

Another embodiment of the present invention provides a method for providing route guidance services, the method including receiving a route guidance request from a user terminal, retrieving routes from a departure point to a destination point, deriving a plurality of retrieved routes based on the departure point and the destination point, predicting a plurality of required times corresponding to the plurality of retrieved routes, respectively, and determining one or more target routes each of which a stress index is to be calculated among the plurality of retrieved routes considering the plurality of required times, and calculating a first stress index of the determined target route using information on a plurality of stress factors and a plurality of weight values corresponding to the plurality of stress factors, respectively, for the determined target route.

The calculating of the first stress index may include checking a driver type, determining basic weight values of the respective stress factors for each of the target routes, and calculating stress values of the respective stress factors using the basic weight values of the respective stress factors, calculating indexes of the respective stress factors by applying a special weight value to the calculated stress values of the respective stress factors, and calculating a first stress index for each of the target routes by adding up the calculated indexes of the respective stress factors, and the basic weight values may be values given to the respective stress factors.

After the calculating of the first stress index, the method may further include calculating a second stress index of each of the target routes by applying an index reflection ratio to the calculated first stress index for each of the target routes.

In the calculating of the stress values of the respective stress factors, the stress value of each of the stress factors may be calculated by multiplying the basic weight value for each of the stress factors by the number of times each of the stress factors is present.

Each driver type may be distinguishing in that the basic weight value of at least one stress factor among the plurality of the stress factors is high.

In the calculating of the indexes of the respective stress factors, the index of each of the stress factors may be calculated by multiplying the calculated stress value for each of the stress factors by the special weight value, the special weight value may be a value for reflecting a state of the stress factor, and the state of the stress factor may include at least one of whether the stress factor is consecutively present and a length of the stress factor.

The basic weight value for each of the stress factors may be determined based on weather information, whether each of the stress factors is present or absent, the number of times each of the stress factors is present, and whether each of the stress factors is consecutively present for each of the target routes.

The weather information may include information about weather, such as sunny, snowing, or raining, in a region on the target route, and the basic weight value for each of the stress factors may be higher when the weather in the region on the target route is snowing or raining than when the weather in the region on the target route is sunny.

The stress factors may include one or more of a speed bump, a sharp curve section, a frequent accident spot, a tunnel section, a road depression section (pothole), a one-way road, an overspeed monitoring camera, a child protection zone (school zone), a senior protection zone, a traffic light without a crosswalk and an unprotected left turn signal, a traffic light with a crosswalk, a traffic light with an unprotected left turn signal, and a traffic light with a crosswalk and an unprotected left turn signal.

The determining of the one or more target routes may include determining, as the target routes, one or more routes each of which a required time is 120% or less of a shortest required time among the plurality of retrieved routes.

According to an embodiment of the present invention, it is possible to provide a system and a method for providing route guidance services capable of retrieving a route in which a driver’s taste is reflected and reducing driver’s driving stress.

### BRIEF DESCRIPTION OF THE DRAWINGS

FIG. 1 is a schematic block diagram illustrating a configuration of a system for providing route guidance services according to an exemplary embodiment.

FIG. 2 is a diagram illustrating an example of a driver type selection screen provided through a user terminal according to an exemplary embodiment.

FIG. 3 is a flowchart of a method for providing route guidance services according to an exemplary embodiment.

FIG. 4 is a detailed flowchart for explaining step S307 of FIG. 3.

FIG. 5 is a diagram illustrating an example for explaining the step S307 of FIG. 3.

FIG. 6 is a diagram illustrating an example of a target route providing screen.

The following reference identifiers may be used in connection with the accompanying drawings to describe exemplary embodiments of the present disclosure.
10: user terminal
101: control unit
103: input unit
105: output unit
107: memory
109: GPS unit
111: communication unit
20: service providing server
201: control module
203: navigation module
205: stress index calculating module
207: index reflection ratio applying module
209: communication module
211: database
30: weather information center
501: traffic light without a crosswalk and an unprotected left turn signal
503: traffic light with an unprotected left turn signal
505: traffic light with crosswalk
507: senior protection zone
509: child protection zone
511: speed bump
513: overspeed monitoring camera
515: tunnel section

### DETAILED DESCRIPTION OF ILLUSTRATIVE EMBODIMENTS

Hereinafter, exemplary embodiments disclosed in the present specification will be described in detail with reference to the accompanying drawings, but the same or similar components will be denoted by the same or similar reference numerals, and an overlapping description thereof will be omitted. Ending words “module” and/or “unit” of terms for components used in the following description are given or combined merely to easily write the specification, and do not have distinct meanings or roles by themselves. In addition, in describing exemplary embodiments disclosed in the present specification, when it is determined that a detailed description of related known technologies may obscure the gist of the exemplary embodiments disclosed in the present specification, the detailed description thereof will be omitted. Further, the accompanying drawings are provided only to help easily understand exemplary embodiments disclosed in the present specification. It should be understood that the technical spirit disclosed in the present specification is not limited by the accompanying drawings, and the accompanying drawings include all modifications, equivalents, and substitutions that fall within the technical spirit and scope of the present invention.

Terms including ordinal numbers such as first and second may be used to describe various components, but these components are not limited by these terms. These terms are used only for the purpose of distinguishing one component from another component.

It should be understood that terms “include”, “have”, and the like used in the present application specify the presence of features, numerals, steps, operations, components, parts, or combinations thereof described in the specification, but do not preclude the presence or addition of one or more other features, numerals, steps, operations, components, parts, or a combination thereof.

Among configurations according to an embodiment, a configuration for controlling another configuration under a specific control condition may have a program installed therein and implemented by a set of instructions embodying a control algorithm required to control another configuration. The control configuration may process input data and stored data according to the installed program to generate output data. The control configuration may include a non-volatile memory storing the program and a memory storing the data.

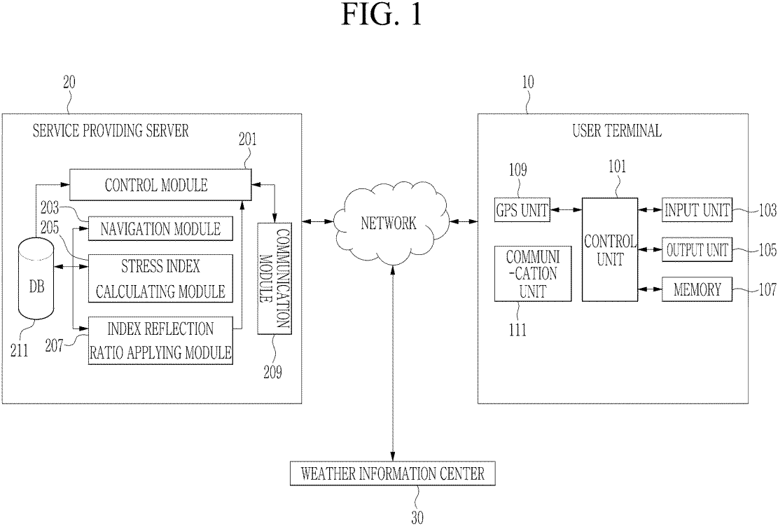

FIG. 1 is a schematic block diagram illustrating a configuration of a system for providing route guidance services according to an exemplary embodiment.

A user terminal 10, a service providing server 20, and a weather information center 30 may be connected to each other through a network.

In embodiments of the present invention, the network may be a personal area network (PAN), a local area network (LAN), a campus area network (CAN), a metropolitan area network (MAN), a wide area network (WAN), a broadband network (BBN), a wireless LAN (WLAN), a storage area network (SAN), or a controller area network (CAN), or may be a cellular communication such as long term evolution (LTE), LTE advanced (LTE-A), code-division multiple access (CDMA), wideband code division multiplex access (WCDMA), universal mobile telecommunication system (UMTS), wireless broadband (WiBro), or global system for mobile communications (GSM), but is not limited thereto.

The user terminal 10 includes a control unit 101, an input unit 103, an output unit 105, a memory 107, a GPS unit 109, and a communication unit 111.

The user terminal 10 may be a mobile terminal or a telematics terminal, but is not limited thereto. The mobile terminal may be implemented in various forms. For example, the mobile terminal may be a mobile phone, a smartphone, a notebook computer, a digital broadcasting terminal, a personal digital assistant (PDA), a portable multimedia player (PMP), and a navigation device (vehicle navigation device).

The user terminal 10 may be installed in a user’s vehicle. In a case where the user terminal 10 is a mobile terminal, the user terminal 10 may be installed or mounted in the user’s vehicle in a detachable manner when used. In a case where the user terminal 10 is a telematics terminal, the user terminal 10 may be fixed to the vehicle.

The control unit 101 may control an overall operation of the input unit 103, the output unit 105, the memory 107, the GPS unit 109, and the communication unit 111.

The input unit 103 may generate input data for controlling an operation of the user terminal 10. The input unit 103 may include a keypad, a dome switch, a touch pad (static pressure/static electricity), a jog wheel, a jog switch, or the like.

A user may input a departure point, a destination point, and driver information through the input unit 103. The driver information may include information about a driver type, a driving proficiency level, a driving purpose, an age, an accident history, etc. In addition, the user may input an avoidance factor, an additional tolerable time compared to the shortest required time, and an index reflection ratio through the input unit 103.

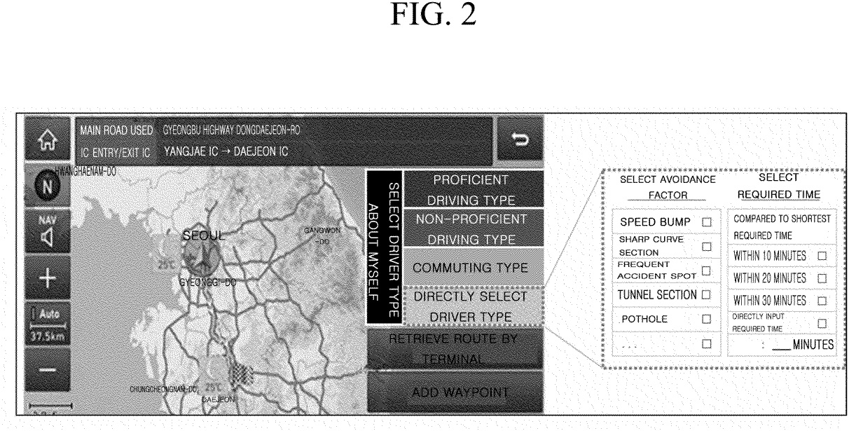

FIG. 2 is a diagram illustrating an example of a driver type selection screen provided through the user terminal according to an exemplary embodiment.

The user may input a driver type, an avoidance factor, and an additional tolerable time compared to the shortest required time through the input unit 103.

As illustrated in FIG. 2, the driver type is classified into a detailed item of “select driver type about myself”. For example, the driver type may be classified as a proficient driving type, a non-proficient driving type, or a commuting type. Through the input unit 103, the user may select any one of the proficient driving type, the non-proficient driving type, and the commuting type as a driver type about himself or herself, or may directly select at least one stress factor as an avoidance factor. When the user directly selects at least one stress factor as an avoidance factor, a control module 201 may update a new driver type including information about the selected stress factor.

A basic weight value for each stress factor may vary depending on the selected driver type. As an example, when the selected driver type is a proficient driving type, basic weight values of a child protection zone 509, a senior protection zone 507, and a pothole, among stress factors, may be higher than those of the other stress factors. As another example, when the selected driver type is a non-proficient driving type, basic weight values of a sharp curve section, a traffic light with an unprotected left turn signal 503, and a frequent accident spot, among stress factors, may be higher than those of the other stress factors. As another example, when the selected driver type is a commuting type, basic weight values of a tunnel section 515, a traffic light without a crosswalk and an unprotected left turn signal 501, and an overspeed monitoring camera 513, among stress factors, may be higher than those of the other stress factors.

The control module 201 may automatically set a driver type when predetermined conditions are met. For example, when the driver’s age is 70 years or older and the driver has many accident histories, the control module 201 may automatically set a driver type to the non-proficient driving type. In addition, the control module 201 can automatically set an avoidance factor by analyzing location data. For example, when a highway travelling ratio is high as a result of analyzing the location data, the control module 201 may automatically set a stress factor that may be an obstacle as an avoidance factor if the user has a habit of driving at a high speed in a sharp curve section, a frequent accident spot, or the like.

The output unit 105 may output an audio signal (or a signal related to an auditory sense), a video signal (or a signal related to a visual sense), an alarm signal, or a signal related to a tactile sense. For example, the output unit 105 may display information about each target route including a second stress index through a display.

The memory 107 may be at least one type of storage medium among a flash type memory, a hard disk type memory, a multimedia card micro type memory, a card type memory (e.g., an SD or XD memory or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In addition, in a case where the user terminal 10 is a mobile terminal, the memory 107 may run a web storage that performs a storage function of the memory on the Internet, or may be operated in association with the web storage.

The memory 107 may store programs for processing and control of the control unit 101, input data of the input unit 103, output data of the output unit 105, map information for displaying route guidance information on maps, etc. In addition, the memory 107 may store location data of the user terminal 10 received from the GPS unit 109, information about retrieved routes received from the service providing server 20, and the user’s driving information.

The GPS unit 109 may receive a GPS signal for tracking a driving route from a departure point to a destination point, and may generate current location data based on the received GPS signal. For example, the user terminal 10 may be installed in the vehicle, and in this case, the location data generated by the GPS unit 109 may be location data of the vehicle. The location data generated by the GPS unit 109 may be stored in the memory 107.

The communication unit 111 may transmit a control command of the control unit 101 to the outside through a network, and may transmit information received from the outside to the control unit 101.

The service providing server 20 includes a control module 201, a navigation module 203, a stress index calculating module 205, an index reflection ratio applying module 207, a communication module 209, and a database 211.

When receiving a route guidance request from the user terminal 10 through the communication unit 111, the control module 201 may operate the navigation module 203, the stress index calculating module 205, and the index reflection ratio applying module 207. When receiving information about each target route from the index reflection ratio applying module 207, the control module 201 may transmit the information about each target route to the user terminal 10 through the communication module 209.

The control module 201 may write, into the database 211, weather information received from the weather information center 30, and information received from the user terminal 10, including input data of the input unit 103, location data, etc.

The navigation module 203 performs a typical navigation function. For example, the navigation module 203 may retrieve routes from a departure point to a destination point. Here, the retrieved routes may include a shortest distance route, a shortest time route, or an optimal route based on road conditions.

The stress index calculating module 205 may calculate a first stress index for each target route.

The first stress index refers to a value calculated using stress factors and weight information. The lower the first stress index is, the less stress the driver may have when driving the corresponding route.

The index reflection ratio applying module 207 may calculate a second stress index of each target route by applying an index reflection ratio to the calculated first stress index for each target route. For example, the second stress index may be calculated by multiplying the first stress index by the index reflection ratio. The second stress index may be displayed through the output unit 105.

The database 211 may store data for calculating a stress index for each target route.

The database 211 may store a navigation program for retrieving routes from a departure point to a destination point, stress factors, a basic weight value for each stress factor based on weather information and driver type, inter-node stress factor data, weather information received from the weather information center 30, input data of the input unit 103, location data, avoidance factors input by the user, a first stress index for each target route, a second stress index for each target route, etc.

The node, which is a point for determining a unit section in which stress factor data is collected, may be previously set. For example, the node may be a point at which a road name is changed in a case where the road is a general road, or an intersection in a case where the road is a highway or a high-speed road. The target route may include one or more nodes.

The inter-node stress factor data, which is data about a road between adjacent nodes, including whether each stress factor is present or absent, the number of times each stress factor is present, whether each stress factor is consecutively present, a length of a stress factor section in a case where the stress factor is a tunnel section 515, etc., may be previously collected and stored in the database. Whether each stress factor is consecutively present indicates whether each stress factor is consecutively present within a predetermined unit distance (e.g., a distance between adjacent nodes).

The weather information center 30 may transmit weather information to the service providing server 20 through a network. The stress index calculating module 205 may check weather in a region on a target route based on weather information received from the control module 201. Here, when the weather is snowing or raining, a basic weight value for each of factors classified into a driving environment category, among the stress factors, may be higher than those of the other stress factors.

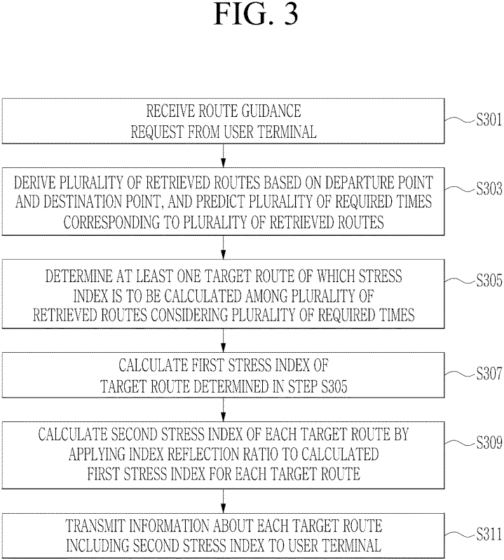

FIG. 3 is a flowchart of a method for providing route guidance services according to an exemplary embodiment.

The service providing server 20 receives a route guidance request from the user terminal 10 through the communication module 209 (S301).

The service providing server 20 may derive a plurality of retrieved routes based on a departure point and a destination point, and predict a plurality of required times corresponding to the plurality of retrieved routes, respectively (S303).

The navigation module 203 may check a departure point and a destination point through input data stored in the database 211, derive a plurality of retrieved routes from the departure point to the destination point, and predict a time required for each of the plurality of retrieved routes in consideration of traffic situations. In this case, the departure point may be a location input by the user through the input unit 103 or a current location according to location data recognized by the GPS unit 109.

The service providing server 20 may determine at least one target route of which a stress index is to be calculated, among the plurality of retrieved routes, considering the plurality of required times (S305).

For example, the stress index calculating module 205 may determine, as a target route, a retrieved route of which a required time is 120% or less of the shortest required time among the plurality of retrieved routes. When a value of an additional tolerable time compared to the shortest required time is input by the user, the stress index calculating module 205 may determine a target route based on the value input by the user. The stress index calculating module 205 may transmit information about the determined target route to the control module 201.

The service providing server 20 calculates a first stress index of the target route determined in the step S305 (S307).

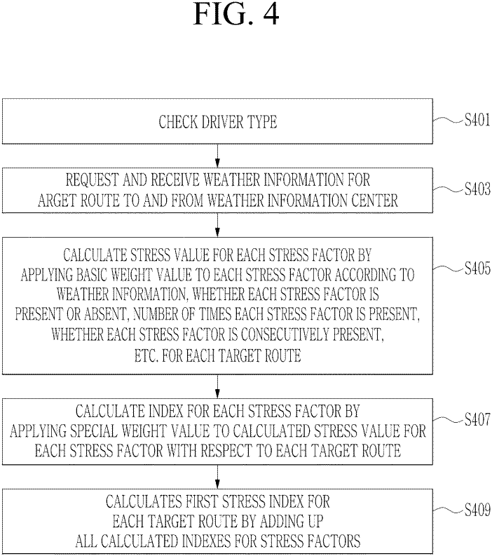

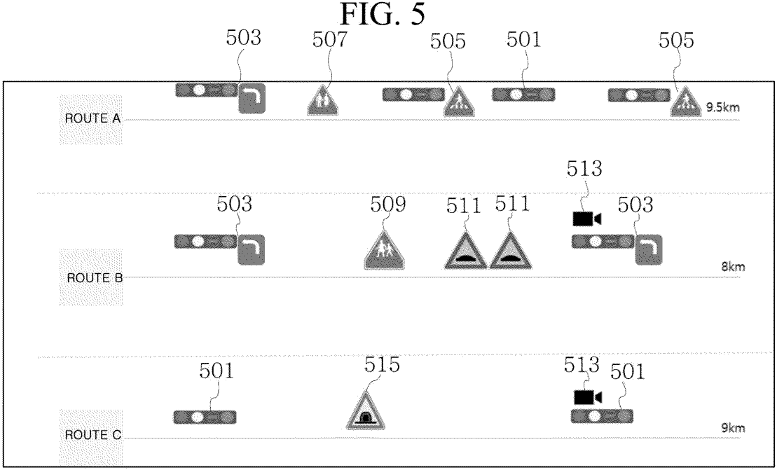

Hereinafter, a method of calculating the first stress index of the target route will be described with reference to FIGS. 4 and 5.

FIG. 4 is a detailed flowchart for explaining the step S307 of FIG. 3.

FIG. 5 is a diagram illustrating an example for explaining the step S307 of FIG. 3.

The stress index calculating module 205 checks a driver type through input data of the input unit 103 stored in the database 211 (S401).

For example, the input driver type may be a proficient driving type.

The control module 201 may request and receive weather information for the target route to and from the weather information center 30 through the communication module 209 (S403).

The weather information may include information about weather, such as sunny, snowing, or raining, in a region on the target route.

For example, the weather in the region on the target route may be sunny.

The control module 201 may transmit the received weather information about the target route to the stress index calculating module 205.

The stress index calculating module 205 calculates a stress value for each stress factor by applying a basic weight value to each stress factor according to weather information, whether each stress factor is present or absent, the number of times each stress factor is present, whether each stress factor is consecutively present, etc. for each target route (S405).

The stress index calculating module 205 may determine basic weight values for the respective stress factors based on the weather and the driver type, and calculate a stress value based on the number of stress factors and the basic weight values.

The stress factor may include a speed bump 511, a sharp curve section, a frequent accident spot, a tunnel section 515, a road depression section (pothole), a one-way road, an overspeed monitoring camera 513, a child protection zone 509 (school zone), a senior protection zone 507, a traffic light without a crosswalk and an unprotected left turn signal 501, a traffic light with a crosswalk 505, a traffic light with an unprotected left turn signal 503, a traffic light with a crosswalk and an unprotected left turn signal, etc. Here, the stress factors may be classified into a driving obstacle category, a driving environment category, an accident monitoring category, a law observance category, and a time pressure category based on characteristics thereof. For example, the speed bump 511 may be classified into the driving obstacle category. The sharp curve section, the frequent accident spot, the tunnel section 515, the road depression section (pothole), and the one-way road may be classified into the driving environment category. The overspeed monitoring camera 513 may be classified into the accident monitoring category. The child protection zone 509 (school zone) and the senior protection zone 507 may be classified into the law observance category. The traffic light without a crosswalk and an unprotected left turn signal 501, the traffic light with a crosswalk 505, the traffic light with an unprotected left turn signal 503, and the traffic light with a crosswalk and an unprotected left turn signal may be classified into the time pressure category.

The basic weight value, which is a specific value given to the stress factor, may be initially set to 1.0. The basic weight value may vary depending on the selected driver type, and the user may customize the basic weight value for each stress factor.

The basic weight value for each stress factor may be higher when the weather in the region on the target route is snowing or raining than when the weather in the region on the target route is sunny. For example, snow or rain may cause greater changes in the basic weight values of the sharp curve section, the frequent accident spot, the tunnel section 515, the pothole, and the one-way road classified into the driving environment category among the stress factors than the other stress factors. Specifically, when the weather is sunny while the driver type is a proficient driving type, the basic weight value of the speed bump 511 may be 0.8, and the basic weight value of the pothole may be 1.3. On the other hand, when the weather is raining or snowing while the driver type is a proficient driving type, the basic weight value of the speed bump 511 may be 1.3, and the basic weight value of the pothole may be 2.8.

The stress index calculating module 205 may calculate a stress value for each stress factor by multiplying the basic weight value for each stress factor by the number of times each stress factor is present.

As an example, it is assumed that target route A includes one traffic light without a crosswalk and an unprotected left turn signal 501, two traffic lights with crosswalks 505, one traffic light with an unprotected left turn signal 503, and one senior protection zone 507. The stress index calculating module 205 may learn from the information stored in the database 211 that, when the weather is sunny and the driver type is a proficient driving type, the basic weight value of the traffic light without a crosswalk and an unprotected left turn signal 501 is 0.8, the basic weight value of the traffic light with a crosswalk 505 is 0.96, the basic weight value of the traffic light with an unprotected left turn signal 503 is 1.2, and the basic weight value of the senior protection zone 507 is 1.5. Therefore, the stress index calculating module 205 may calculate a stress value of the traffic light without a crosswalk and an unprotected left turn signal 501 as 0.8*1=0.8, calculate a stress value of the traffic light with a crosswalk 505 as 0.96*2=1.92, calculate a stress value of the traffic light with an unprotected left turn signal 503 as 1.2*1=1.2, and calculate a stress value of the senior protection zone 507 as 1.5*1=1.5.

As another example, it is assumed that target route B includes two traffic lights with unprotected left turn signals 503, one child protection zone 509, one overspeed monitoring camera 513, and two speed bumps 511 that are consecutively present. The stress index calculating module 205 may learn from the information stored in the database 211 that, when the weather is sunny and the driver type is a proficient driving type, the basic weight value of the traffic light with an unprotected left turn signal 503 is 1.2, and the basic weight value of the child protection zone 509 is 1.6, the basic weight value of the overspeed monitoring camera 513 is 0.8, and the basic weight value of the speed bump 511 is 0.8. Therefore, the stress index calculating module 205 may calculate a stress value of the traffic light with an unprotected left turn signal 503 as 1.2*2=2.4, calculate a stress value of the child protection zone 509 as 1.6*1=1.6, calculate a stress value of the overspeed monitoring camera 513 as 0.8*1=0.8, and calculate a stress value of the speed bump 511 as 0.8*2=1.6.

As another example, it is assumed that target route C includes two traffic lights without crosswalks and unprotected left turn signals 501, one overspeed monitoring camera 513, and one tunnel section 515 having a length of 5 km or more. The stress index calculating module 205 may learn from the information stored in the database 211, that when the weather is sunny and the driver type is a proficient driving type, the basic weight value of the traffic light without a crosswalk and an unprotected left turn signal 501 is 0.8, the basic weight value of the overspeed monitoring camera 513 is 0.8, and the basic weight value of the tunnel section 515 is 0.8. Therefore, the stress index calculating module 205 may calculate a stress value of the traffic light without a crosswalk and an unprotected left turn signal 501 as 0.8*2=1.6, calculate a stress value of the overspeed monitoring camera 513 as 0.8%1=0.8, and calculate a stress value of the tunnel section 515 as 0.8*1=0.8.

The stress index calculating module 205 calculates an index for each stress factor by applying a special weight value to the calculated stress value for each stress factor with respect to each target route (S407).

The special weight value, which is a value for reflecting a state of the stress factor, may be initially set to 1.0. As an example, the special weight value may be 1.2 when speed bumps 511 are consecutively present, or may be 1.2 when the tunnel section 515 has a length of 5 km or more. As another example, the special weight value may be 1.2 when at least one of the stress factors classified into the driving environment category is consecutively present.

The stress index calculating module 205 may calculate an index for each stress factor by multiplying the calculated stress value for each stress factor by the special weight value.

As an example, for the target route A, the stress index calculating module 205 may calculate an index of the traffic light without a crosswalk and an unprotected left turn signal 501 as 0.8*1=0.8, calculate an index of the traffic light with a crosswalk 505 as 1.92*1=1.92, calculate an index of the traffic light with an unprotected left turn signal 503 as 1.2*1=1.2, and calculate an index of the senior protection zone 507 as 1.5*1=1.5.

As an example, for the target route B, the stress index calculating module 205 may calculate an index of the traffic light with an unprotected left turn signal 503 as 2.4*1=2.4, calculate an index of the child protection zone 509 as 1.6*1=1.6, calculate an index of the overspeed monitoring camera 513 as 0.8%1=0.8, and calculate an index of the speed bump 511 as 1.6*1.2(special weight value)=1.92.

As an example, for the target route C, the stress index calculating module 205 may calculate an index of the traffic light without a crosswalk and an unprotected left turn signal 501 as 1.6*1=1.6, calculate an index of the overspeed monitoring camera 513 as 0.8*1=0.8, and calculate an index of the tunnel section 515 when the tunnel section 515 has a length of 5 km or more as 0.8*1.2(special weight value)=0.96.

The stress index calculating module 205 calculates a first stress index for each target route by adding up all the calculated indexes for stress factors (S409).

As an example, for the target route A, the stress index calculating module 205 may calculate a first stress index of the target route A as 5.42 by adding up 0.8 which is the index of the traffic light without a crosswalk and an unprotected left turn signal 501, 1.92 which is the index of the traffic light with a crosswalk 505, 1.2 which is the index of the traffic light with an unprotected left turn signal 503, and 1.5 which is the index of the senior protection zone 507.

As another example, for the target route B, the stress index calculating module 205 may calculate a first stress index of the target route B as 6.72 by adding up 2.4 which is the index of the traffic light with an unprotected left turn signal 503, 1.6 which is the index of the child protection zone 509, 0.8 which is the index of the overspeed monitoring camera 513, and 1.92 which is the index of the speed bump 511.

As another example, for the target route C, the stress index calculating module 205 may calculate a first stress index of the target route C as 5.76 by adding up 1.6 which is the index of the traffic light without a crosswalk and an unprotected left turn signal 501, 0.8 which is the index of the overspeed monitoring camera 513, and 0.96 which is the index of the tunnel section 515 having a length of 5 km or more.

Thereafter, the service providing server 20 calculates a second stress index for each target route by applying an index reflection ratio to the calculated first stress index for each target route (S30₉).

The index reflection ratio may be determined according to how much the user tolerates stress factors. The index reflection ratio may be any value within a range of 0 to 100%. For example, when the user is able to tolerate 40% of any one of the stress factors, the index reflection ratio may be 60%.

The index reflection ratio applying module 207 may check an index reflection ratio from input data of the input unit 103 stored in the database 211. For example, the index reflection ratio applying module 207 may calculate a second stress index for each target route by multiplying the calculated first stress index for each target route by the index reflection ratio.

As an example, when the first stress index is 15 and the index reflection ratio is 100%, the second stress index is 15. As another example, when the first stress index is 15 and the index reflection ratio is 50%, the second stress index is 7.5.

The service providing server 20 transmits information about each target route including the second stress index to the user terminal (S311).

The information about the target route may include at least one of a departure point, a destination point, a feature of a route (e.g., a healthy route or a minimum time route), a time required from the departure point to the destination point, an expected arrival time, a distance between the departure point and the destination point, an estimated cost, an estimated taxi fare, and a second stress index.

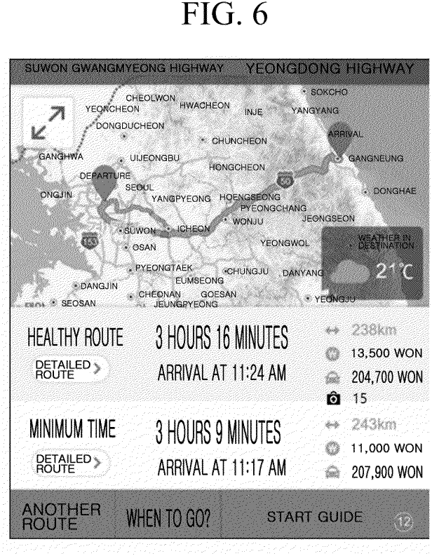

FIG. 6 is a diagram illustrating an example of a target route providing screen.

The control unit 101 may instruct the output unit 105 to output received information about each target route.

The user terminal 10 may display a second stress index and at least one ‘healthy route’. For example, the ‘healthy route’ may be a route with the lowest second stress index among target routes. As a specific example, in FIG. 5, since the first stress index of the target route A is lowest, the user terminal 10 may display information about the target route A as a ‘healthy route’ on the screen.

For example, as information about the ‘healthy route’, the output unit 105 may display on the screen that a required time is 3 hours and 16 minutes, a distance is 238 km, a required cost is 13,500 won, a taxi fare is 204,700 won, and a second stress index is 15.

The system for providing route guidance services according to the present exemplary embodiment is capable of retrieving a route in which a driver’s preference is reflected, and reducing a driving stress of the driver.

Although the exemplary embodiments of the present invention have been described in detail above, the scope of the present invention is not limited thereto, and various modifications and alterations made by those skilled in the art also fall within the scope of the present invention.

What is claimed is:

1. A system for providing route guidance services, the system comprising:
a service providing server configured to:
receive a route guidance request from a user terminal;
derive a plurality of retrieved routes based on a departure point and a destination point;
predict a plurality of required times corresponding to the plurality of retrieved routes, respectively;
determine a target route of which a stress index is to be calculated among the plurality of retrieved routes considering the plurality of required times;
calculate a first stress index of the determined target route using information on a plurality of stress factors and a plurality of weight values corresponding to the plurality of stress factors, respectively, for the determined target route; and
transmit information about target routes to the user terminal in response to the route guidance request.

2. The system of claim 1, wherein the service providing server includes:
a navigation module configured to retrieve routes from the departure point to the destination point; and
a stress index calculating module configured to:
check a driver type;
determine basic weight values of the respective stress factors for each of the target routes, the basic weight values being values given to the respective stress factors;
calculate stress values of the respective stress factors using the basic weight values of the respective stress factors;
calculate indexes of the respective stress factors by applying a special weight value to the calculated stress values of the respective stress factors; and
calculate a first stress index for each of the target routes by adding up the calculated indexes of the respective stress factors.

3. The system of claim 2, further comprising:
an index reflection ratio applying module configured to calculate a second stress index of each of the target routes by applying an index reflection ratio to the calculated first stress index for each of the target routes.

4. The system of claim 2, wherein he stress index calculating module is further configured to calculate the stress value of each of the stress factors by multiplying the basic weight value for each of the stress factors by the number of times each of the stress factors is present.

5. The system of claim 2, wherein each driver type is distinguished in that the basic weight value of at least one stress factor among the plurality of stress factors is high.

6. The system of claim 2, wherein the stress index calculating module is further configured to:
calculate the index of each of the plurality of stress factors by multiplying the calculated stress value for each of the plurality of stress factors by the special weight value, the special weight value is a value for reflecting a state of the stress factor, and the state of the stress factor includes at least one of whether the stress factor is consecutively present and a length of the stress factor.

7. The system of claim 2, wherein the basic weight value for each of the plurality of stress factors is determined based on weather information, whether each of the plurality of stress factors is present or absent, the number of times each of the plurality of stress factors is present, and whether each of the plurality of stress factors is consecutively present for each of the target routes.

8. The system of claim 7, wherein the weather information includes information about weather, such as sunny, snowing, or raining, in a region on the target route, and the basic weight value for each of the stress factors is higher when the weather in the region on the target route is snowing or raining than when the weather in the region on the target route is sunny.

9. The system of claim 1, wherein the plurality of stress factors include one or more of a speed bump, a sharp curve section, a frequent accident spot, a tunnel section, a road depression section (pothole), a one-way road, an overspeed monitoring camera, a child protection zone (school zone), a senior protection zone, a traffic light without a crosswalk and an unprotected left turn signal, a traffic light with a crosswalk, a traffic light with an unprotected left turn signal, and a traffic light with a crosswalk and an unprotected left turn signal.

10. The system of claim 1, wherein the target routes are one or more routes each of which a required time is 120% or less of a shortest required time among the plurality of retrieved routes.

11. A method for providing route guidance services, the method comprising:
receiving a route guidance request from a user terminal;
retrieving routes from a departure point to a destination point;
deriving a plurality of retrieved routes based on the departure point and the destination point;
predicting a plurality of required times corresponding to the plurality of retrieved routes, respectively;
determining one or more target routes each of which a stress index is to be calculated among the plurality of retrieved routes considering the plurality of required times; and
calculating a first stress index of the determined target route using information on a plurality of stress factors and a plurality of weight values corresponding to the plurality of stress factors, respectively, for the determined target route.

12. The method of claim 11, wherein the calculating of the first stress index includes:
checking a driver type;
determining basic weight values of the respective stress factors for each of the target routes;
calculating stress values of the respective stress factors using the basic weight values of the respective stress factors;
calculating indexes of the respective stress factors by applying a special weight value to the calculated stress values of the respective stress factors; and
calculating a first stress index for each of the target routes by adding up the calculated indexes of the respective stress factors; and
the basic weight values are values given to the respective stress factors.

13. The method of claim 12, further comprising:
after the calculating of the first stress index, calculating a second stress index of each of the target routes by applying an index reflection ratio to the calculated first stress index for each of the target routes.

14. The method of claim 12, wherein in the calculating of the stress values of the respective stress factors, the stress value of each of the stress factors is calculated by multiplying the basic weight value for each of the stress factors by the number of times each of the stress factors is present.

15. The method of claim 12, wherein each driver type is distinguished in that the basic weight value of at least one stress factor among the plurality of stress factors is high.

16. The method of claim 12, wherein in the calculating of the indexes of the respective stress factors, the index of each of the stress factors is calculated by multiplying the calculated stress value for each of the stress factors by the special weight value, the special weight value is a value for reflecting a state of the stress factor, and the state of the stress factor includes at least one of whether the stress factor is consecutively present and a length of the stress factor.

17. The method of claim 12, wherein the basic weight value for each of the stress factors is determined based on weather information, whether each of the stress factors is present or absent, the number of times each of the stress factors is present, and whether each of the stress factors is consecutively present for each of the target routes.

18. The method of claim 17, wherein the weather information includes information about weather, such as sunny, snowing, or raining, in a region on the target route, and the basic weight value for each of the stress factors is higher when the weather in the region on the target route is snowing or raining than when the weather in the region on the target route is sunny.

19. A method for providing route guidance services, the method comprising:
receiving a route guidance request from a user terminal;
retrieving routes from a departure point to a destination point;
deriving a plurality of retrieved routes based on the departure point and the destination point;
predicting a plurality of required times corresponding to the plurality of retrieved routes, respectively;
determining one or more target routes each of which a stress index is to be calculated among the plurality of retrieved routes considering the plurality of required times;
calculating a first stress index of the determined target route using information on a plurality of stress factors and a plurality of weight values corresponding to the plurality of stress factors, respectively, for the determined target route, the plurality of stress factors including one or more of a speed bump, a sharp curve section, a frequent accident spot, a tunnel section, a road depression section, a one-way road, an overspeed monitoring camera, a child protection zone, a senior protection zone, a traffic light without a crosswalk and an unprotected left turn signal, a traffic light with a crosswalk, a traffic light with an unprotected left turn signal, and a traffic light with a crosswalk and an unprotected left turn signal; and
transmitting information about target routes to the user terminal in response to the route guidance request.

20. The method of claim 19, wherein the determining of the one or more target routes includes determining, as the target routes, one or more routes each of which a required time is 120% or less of a shortest required time among the plurality of retrieved routes.
